(19) United States
(12) Patent Application Publication
(10) Pub. No.: US 2020/0148289 A1
(43) Pub. Date: May 14, 2020

(54) ADJUSTABLE TIRE CARRIERS FOR VEHICLES

(71) Applicant: ICON VEHICLE DYNAMICS LLC, Riverside, CA (US)

(72) Inventor: Dylan Samuel Evans, Corona, CA (US)

(21) Appl. No.: 16/671,459

(22) Filed: Nov. 1, 2019

Related U.S. Application Data
(60) Provisional application No. 62/758,199, filed on Nov. 9, 2018.

(51) Int. Cl. B62D 43/02

(52) U.S. Cl. CPC B62D 43/02

(57) ABSTRACT

An adjustable tire carrier includes: a first member configured to be attached to a vehicle; a second member configured to have a spare tire attached thereto; and an adjustment mechanism configured to selectively move the second member with respect to the first member, and to selectively retain the second member in at least a raised position or a lowered position.

### CROSS-REFERENCE TO RELATED APPLICATIONS

This application claims the benefit of U.S. Provisional Application No. 62/758,199, titled ADJUSTABLE TIRE CARRIERS FOR VEHICLES, filed Nov. 9, 2018, which is hereby incorporated by reference herein in its entirety.

### BACKGROUND

### Field

The disclosure relates generally to the field of off-road vehicles, and more specifically to spare tire carriers for off-road vehicles.

### SUMMARY

The disclosure herein presents various embodiments of adjustable and/or reconfigurable tire carriers. For example, various embodiments disclosed herein comprise a spare tire carrier intended to be attached to and/or adjacent a rear end of an off-road vehicle, such as a sport utility vehicle. The spare tire carrier is adjustable such that the position of a spare tire mounted thereto can be adjusted with respect to the vehicle. For example, the spare tire may be moved into a raised position or a lowered position. Such an adjustable spare tire carrier can be beneficial, for example, because placing the spare tire in a raised position may help to increase the departure angle of the vehicle when needed (such as when the vehicle is crawling over large obstacles), and placing the spare tire in a lowered position may help to increase rearward visibility of a driver of the vehicle when such increased departure angle is not needed.

According to some embodiments, an adjustable tire carrier comprises: a first member configured to be attached to a vehicle; a second member configured to have a spare tire attached thereto; a first arm having a first end pivotally coupled to the first member at a first pivot axis, and a second end pivotally coupled to the second member at a second pivot axis; a second arm having a first end pivotally coupled to the first member at a third pivot axis, and a second end pivotally coupled to the second member at a fourth pivot axis, wherein the first arm and the second arm are configured to enable the second member to move with respect to the first member between a raised position and a lowered position; one or more biasing member configured to bias the second member toward the raised position; and a clutch mechanism configured to selectively lock the second member in at least the raised position or the lowered position, wherein the clutch mechanism comprises: a plurality of clutch plates comprising one or more first clutch plates that are rotationally constrained with respect to one of the first member or the second member, and one or more second clutch plates that are rotationally constrained with respect to one of the first arm or the second arm; and a movable handle configured to selectively apply a longitudinal clamping force to the plurality of clutch plates to resist rotation of the one or more first clutch plates with respect to the one or more second clutch plates.

In some embodiments, the one of the first member or the second member comprises a first flange and a second flange that are spaced apart and form a space therebetween, with the plurality of clutch plates being positioned between the first flange and the second flange, and the adjustable tire carrier further comprises: a shaft that defines one of the first, second, third, or fourth pivot axes, the shaft having a first end and a second end, wherein the shaft passes through the first flange, the second flange, and the plurality of clutch plates, and wherein the movable handle is configured to selectively apply the longitudinal clamping force by clamping the first flange and the second flange between the first end of the shaft and the handle such that the first flange and the second flange deflect inwardly toward the plurality of clutch plates. In some embodiments, the second end of the shaft is threaded, and the moveable handle comprises a thread that engages the threaded second end of the shaft. In some embodiments, the clutch mechanism further comprises a plurality of clutch washers interposed between the plurality of clutch plates. In some embodiments, the one or more first clutch plates are rotationally constrained with respect to the first member, the one or more second clutch plates are rotationally constrained with respect to the first arm, and the adjustable tire carrier further comprises: a second clutch mechanism comprising: a plurality of clutch plates comprising one or more third clutch plates that are rotationally constrained with respect to the second member, and one or more fourth clutch plates that are rotationally constrained with respect to the second arm; and a second movable handle configured to selectively apply a longitudinal clamping force to the plurality of clutch plates of the second clutch mechanism to resist rotation of the one or more third clutch plates with respect to the one or more fourth clutch plates. In some embodiments, the first member comprises a u-shaped bracket comprising a left sidewall and a right sidewall that form a space therebetween, and the first end of one or both of the first and second arms is positioned within the space formed between the left and right sidewalls. In some embodiments, the second member comprises a u-shaped bracket comprising a left sidewall and a right sidewall that form a space therebetween, and the second end of one or both of the first and second arms is positioned within the space formed between the left and right sidewalls of the second member. In some embodiments, the first pivot axis and the second pivot axis define a first line that passes through and is perpendicular to both of the first pivot axis and the second pivot axis, the third pivot axis and the fourth pivot axis define a second line that passes through and is perpendicular to both of the third pivot axis and the fourth pivot axis, and the second line is non-parallel to the first line when the second member is in at least one of the raised position or the lowered positon. In some embodiments, the second pivot axis and the fourth pivot axis define a third line that passes through and is perpendicular to both of the second pivot axis and the fourth pivot axis, and the third line is oriented at different angles with respect to a horizontal reference when the second member is in the raised position and when the second member is in the lowered position. In some embodiments, the one or more biasing members comprises a gas strut. In some embodiments, the first arm is positioned above the second arm, the first pivot axis and the second pivot axis define a first line that passes through and is perpendicular to both of the first pivot axis and the second pivot axis, the third pivot axis and the fourth pivot axis define a second line that passes through and is perpendicular to both of the third pivot axis and the fourth pivot axis, the gas strut comprises a first end that pivotally attaches to the first arm at a point that is above the first line, and the gas strut comprises a second end that pivotally attaches to the second arm at a point that is below the second line. In some embodiments, the first pivot axis and the third pivot axis are positioned such that, when the first member is attached to a rear portion of the vehicle and the vehicle is positioned on horizontal surface, the first pivot axis is positioned above the third pivot axis, and the third pivot axis is positioned rearward of the first pivot axis.

According to some embodiments, an adjustable tire carrier comprises: a first member configured to be attached to a vehicle; a second member configured to have a spare tire attached thereto; a first linkage and a second linkage, each of the first and second linkages having a first end pivotally coupled to the first member, and a second end pivotally coupled to the second member, wherein the first and second linkages are configured to enable the second member to move with respect to the first member between a raised position and a lowered position; a biasing member configured to bias the second member toward the raised position; and a locking system configured to selectively prevent the second member from moving with respect to the first member.

In some embodiments, the first linkage is parallel to the second linkage. In some embodiments, the first linkage is non-parallel to the second linkage in at least the raised position or the lowered position. In some embodiments, the biasing member comprises a gas strut. In some embodiments, the first member comprises two side walls connected to a back wall to form a first cavity between the two side walls, the second member comprises two side walls connected to a front wall to form a second cavity between the two side walls of the second member, the first ends of the first and second linkages are positioned within the first cavity, and the second ends of the first and second linkages are positioned within the second cavity. In some embodiments, the locking system comprises a pin coupled to one of the first member or the second member, the pin positioned to selectively engage one or more holes in a part connected to or formed as part of the first linkage, the second linkage, or the other of the first member or the second member. In some embodiments, the locking system comprises a plurality of clutch plates configured to resist rotational motion when a longitudinal clamping force is applied to the plurality of clutch plates.

According to some embodiments, an adjustable tire carrier comprises: a first member configured to be attached to a vehicle; a second member configured to have a spare tire attached thereto; an adjustment mechanism configured to selectively move the second member with respect to the first member between a raised position and a lowered position; and a locking member configured to selectively retain the second member in at least one of the raised position or the lowered position.

According to some embodiments, an adjustable tire carrier comprises: a first member configured to be attached to a vehicle; a second member configured to have a spare tire attached thereto; and an adjustment mechanism configured to selectively move the second member with respect to the first member, and to selectively retain the second member in at least a raised position or a lowered position.

In some embodiments, the adjustable tire carrier further comprises the vehicle, wherein the first member is attached to the vehicle such that, when the spare tire is attached to the second member and the second member is in the raised position, a departure angle of the vehicle will be greater than when the spare tire is attached to the second member and the second member is in the lowered position. In some embodiments, the adjustment mechanism comprises a locking mechanism to selectively retain the second member in the raised position or the lowered position. In some embodiments, the locking mechanism comprises a pin coupled to one of the first member or the second member, the pin positioned to selectively engage one or more holes of the adjustment mechanism or the other of the first member or the second member. In some embodiments, the adjustment mechanism is further configured to selectively retain the second member in a plurality positions between a fully raised position and a fully lowered position. In some embodiments, the adjustment mechanism comprises at least a first linkage and a second linkage, each of the first linkage and the second linkage being pivotally coupled to the first member and the second member. In some embodiments, a first plane defined by two pivot axes of the first linkage is parallel to a second plane defined by two pivot axes of the second linkage. In some embodiments, the adjustment mechanism further comprises at least one biasing member configured to bias the second member toward the raised position. In some embodiments, the at least one biasing member comprises a gas strut. In some embodiments, the adjustment mechanism is configured such that the movement of the second member with respect to the first member comprises translation in only one direction. In some embodiments, the only one direction is substantially vertical when the first member is attached to the vehicle and the vehicle is resting on a horizontal surface. In some embodiments, the adjustment mechanism is configured such that the movement of the second member with respect to the first member comprises translation that includes both vertical and horizontal components when the first member is attached to the vehicle and the vehicle is resting on a horizontal surface. In some embodiments, the first member is configured to be attached to the vehicle via an arm that is pivotally coupled to a rear bumper of the vehicle.

According to some embodiments, an adjustable tire carrier comprises: a first member configured to be attached to a vehicle; a second member configured to have a spare tire attached thereto; a first linkage and a second linkage, each of the first and second linkages having a first end pivotally coupled to the first member, and a second end pivotally coupled to the second member, wherein the first and second linkages are configured to enable the second member to move with respect to the first member between a raised position and a lowered position; a biasing member configured to bias the second member toward the raised position; and a locking member configured to selectively prevent the second member from moving with respect to the first member.

In some embodiments, the adjustable tire carrier further comprises an arm extending from the first member and configured to pivotally couple to a rear bumper of the vehicle. In some embodiments, the arm is configured to pivot with respect to the vehicle about an axis that is substantially perpendicular to pivot axes of the first and second linkages. In some embodiments, the first linkage is positioned above the second linkage. In some embodiments, the first linkage is parallel to the second linkage. In some embodiments, a first plane defined by two pivot axes of the first linkage is parallel to a second plane defined by two pivot axes of the second linkage. In some embodiments, the biasing member comprises a gas strut. In some embodiments, the first member comprises two side walls connected to a back wall to form a cavity between the two side walls, and wherein the first ends of the first and second linkages are positioned within the cavity. In some embodiments, the second member comprises two side walls connected to a front wall to form a second cavity between the two side walls of the second member, and wherein the second ends of the first and second linkages are positioned within the second cavity. In some embodiments, the locking member comprises a pin coupled to one of the first member or the second member, the pin positioned to selectively engage one or more holes in a part connected to or formed as part of the first linkage, the second linkage, or the other of the first member or the second member.

For purposes of this summary, certain aspects, advantages, and novel features of the inventions are described herein. It is to be understood that not necessarily all such advantages may be achieved in accordance with any particular embodiment of the inventions. Thus, for example, those skilled in the art will recognize that the inventions may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects, and advantages of the present inventions are described in detail below with reference to the drawings of various embodiments, which are intended to illustrate and not to limit the inventions. The drawings comprise the following figures in which:

FIGS. 1A-1D illustrate an embodiment of an adjustable tire carrier.

FIGS. 2A and 2B are schematic diagrams illustrating an example usage of an adjustable tire carrier.

FIGS. 3A-3D illustrate another embodiment of an adjustable tire carrier.

FIG. 3E illustrates the adjustable tire carrier of FIG. 3A with a tire attached thereto.

FIG. 3F illustrates a locking assembly of the adjustable tire carrier of FIG. 3A.

### DETAILED DESCRIPTION OF THE EMBODIMENTS

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for their desirable attributes or is essential to practicing the inventions herein described.

Off-road vehicles, such as sport utility vehicles and trucks, are popular, at least in part, because they often have both on-road and off-road capabilities. Off-road enthusiasts often like to have a vehicle that is capable of safe and comfortable on-road drivability, while still being capable of conquering challenging off-road terrain when desired. Particularly when off-roading, the chances of a tire experiencing a failure, such as due to a puncture, is increased, and it can be desirable to have a spare tire available. Further, when navigating complex off-road terrain, it can be desirable for such spare tire to be a full-sized spare, meaning the spare tire is essentially interchangeable with the normal tires, without reducing the off-road capability and durability of the vehicle.

Many off-road vehicles with enhanced off-road capabilities use larger tires than stock. With the desire to have a full-sized spare, where to store such a spare tire can present issues. For example, some off-road sport-utility vehicles, such as Jeep® brand sport-utility vehicles, may store the spare tire adjacent to or against a back wall or door of the vehicle. When a standard sized OEM tire is used, such a storage location may not be problematic. When a larger sized tire is used, however, multiple issues arise. For example, the larger tire size may cause obstruction of the driver's view through the rear window behind the vehicle. If the driver wishes to look behind the vehicle, either directly from the driver seat or via the rearview mirror typically mounted to the windshield, such a large tire stored against the outside of the back wall of the vehicle may obstruct that rearward view. Secondly, when crawling over large obstacles, such as boulders, it can be desirable to maintain a relatively large departure angle. With such a large spare tire, however, a lower portion of that spare tire may extend downward sufficiently to decrease the vehicle's departure angle in comparison to what it would be with an OEM sized spare tire.

The disclosure herein presents various embodiments of adjustable tire carriers that comprise a variety of benefits, including solving the problems discussed above. For example, some embodiments of adjustable tire carriers comprise a first portion that is mounted to the vehicle, and a second portion that is movable with respect to the first portion and that has the spare tire mounted thereto. For example, the second portion may be movable upward and downward with respect to the first portion, thus enabling the spare tire to also be moved upward or downward with respect to the vehicle. In some embodiments, the second portion may also tilt such that the spare tire attached thereto is at a different angle in the lowered position than in the raised position. Various embodiments also include one or more locking mechanisms that enable the second portion to be selectively locked in one or more of the raised position, the lowered position, or any position therebetween.

The adjustable tire carriers disclosed herein can provide various benefits. For example, when the spare tire is in the raised position, this can help to increase ground clearance and departure angle in off-road situations. Further, moving the spare tire to the raised position can be desirable when towing, such as to gain access to the tow point and/or to provide clearance to the trailer that is being towed. When the spare tire is in the lowered position, this may, for example, provide better rear visibility out of the rear window of the vehicle, and may also help to lower the center of gravity of the vehicle, leading to improved vehicle handling.

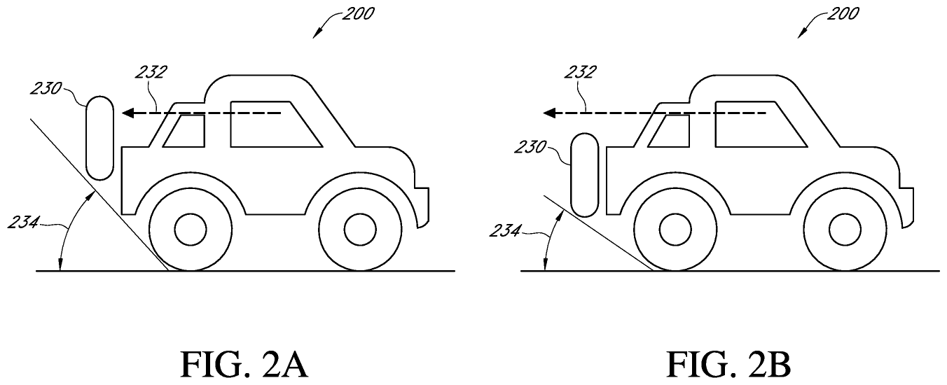

FIGS. 2A and 2B are schematic diagrams that illustrate two of the benefits of an adjustable tire carrier as disclosed herein. With reference to FIGS. 2A and 2B, a side schematic view of a vehicle 200 is illustrated with a spare tire 230 attached adjacent a rear wall of the vehicle 200. Because FIGS. 2A and 2B are merely schematic diagrams, the adjustable tire carrier is not illustrated, but any of the adjustable tire carriers disclosed herein could be used. FIG. 2A illustrates a configuration wherein the spare tire 230 is in a raised position with respect to the vehicle 200. In such a position, the rearward view of the driver, indicated by line 232, is obstructed by the spare tire 230. However, the departure angle 234 is maximized, to enhance off-road capabilities. FIG. 2B illustrates an alternative configuration wherein the spare tire 230 is in a lowered position with respect to the vehicle 200. In such a position, the rearward view of the driver, indicated by line 232, is unobstructed, or at least less obstructed, by the spare tire 230. However, the departure angle 234 is reduced over what it was when the spare tire 230 was shown in the raised position in FIG. 2A. Configurations such as shown in FIGS. 2A and 2B can be beneficial, for example, to allow the lowered position shown in FIG. 2B to be used during on-road driving and some light off-road driving, and to allow the raised position shown in FIG. 2A to be used during more technical off-road driving, such as when crawling over large obstacles such as boulders. Although the schematic diagrams of FIGS. 2A and 2B illustrate the spare tire 230 being oriented perpendicular to a horizontal plane (such as the surface the vehicle is resting on), some embodiments may be configured to have the spare tire 230 be inclined with respect to horizontal (e.g., at an angle other than 90 degrees with respect to horizontal) in one or both of the raised or lowered positions.

### EXAMPLE ADJUSTABLE TIRE CARRIER

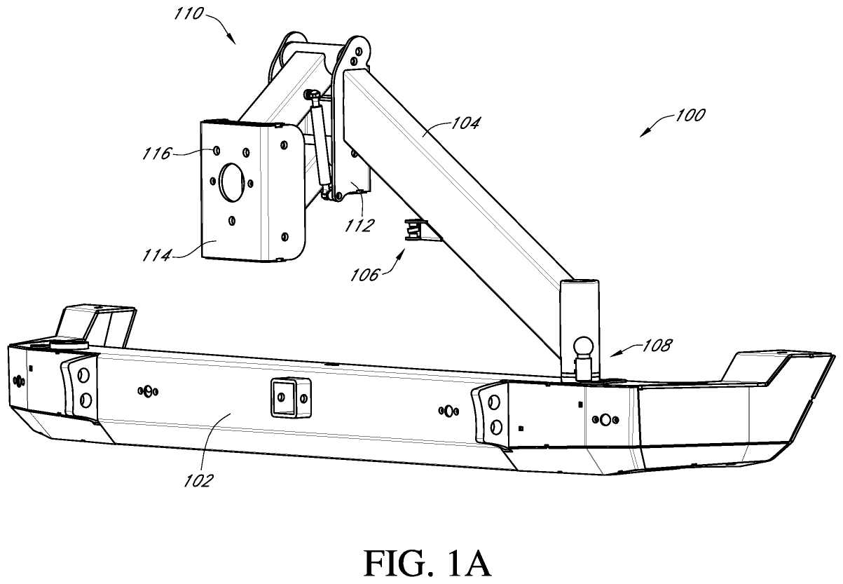

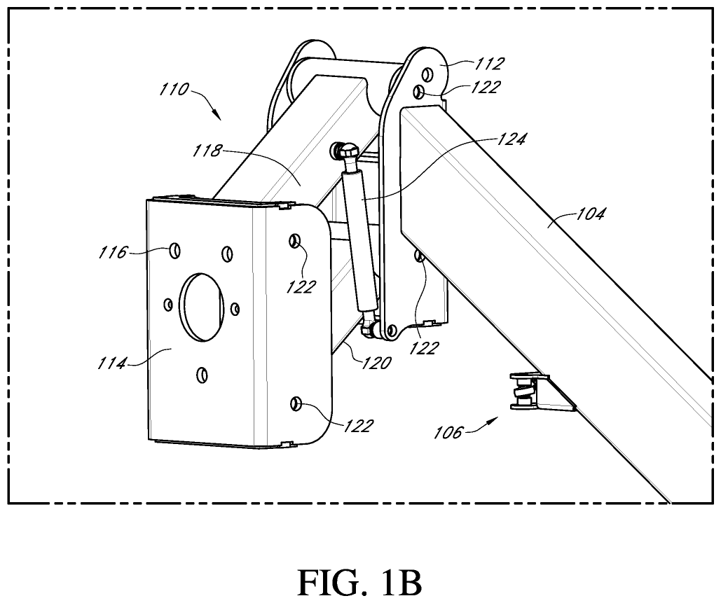

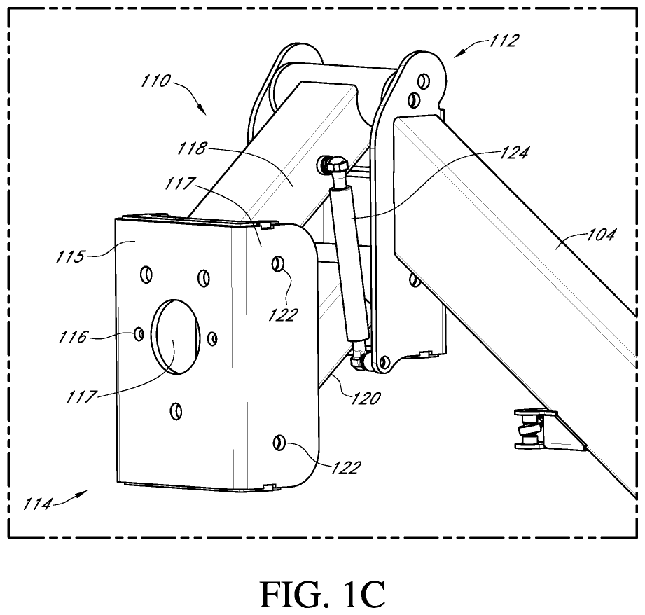

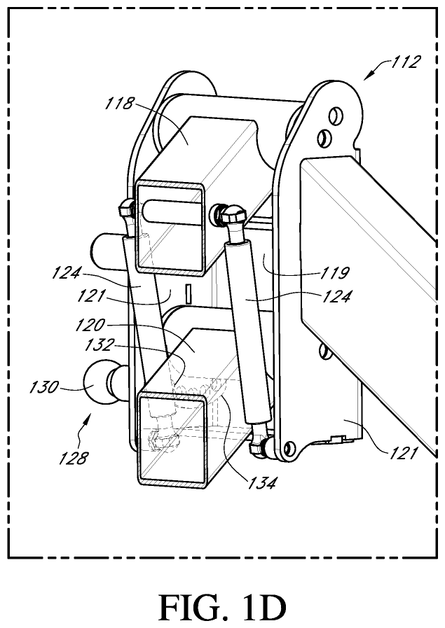

FIGS. 1A-1D illustrate one example embodiment of an adjustable tire carrier 110. FIG. 1A is a perspective view of a rear bumper assembly 100 comprising the adjustable tire carrier 110. FIGS. 1B and 1C are detail views focusing on the adjustable tire carrier 110 of FIG. 1A. FIG. 1D is a cross-sectioned detail view of the adjustable tire carrier 110 of FIG. 1A.

With reference to FIG. 1A, a rear bumper assembly 100 is illustrated. The rear bumper assembly 100 may, for example, be a bumper assembly that could be used with a Jeep® brand sport-utility vehicle. The bumper assembly 100 comprises a bumper 102, the adjustable tire carrier 110, and an arm 104 connected to the bumper 102 at one end and connected to the adjustable tire carrier 110 at its other end. In this embodiment, the arm 104 is pivotally attached to the bumper 102, such as to allow the adjustable tire carrier 110 and arm 104 to be pivoted away from the back wall or door of the vehicle when a user desires to access or open the back wall or door of the vehicle.

The embodiment of FIG. 1A further comprises a latch assembly 106 that can, for example, be coupled to a portion of the back wall or door of the vehicle to maintain the arm 104 in a closed orientation. Further, this embodiment comprises a locking assembly 108 configured to maintain the arm 104 in one or more specific rotational orientations with respect to the bumper 102. For example, the locking assembly 108 may comprise a spring-loaded pin or other member configured to engage one or more holes or detents of or attached to the bumper 102 (operating similarly to the locking assembly 128, described below). In this embodiment, the arm 104 is configured to pivot about an axis that is oriented substantially vertical with respect to the bumper 102. Other embodiments may use other arrangements.

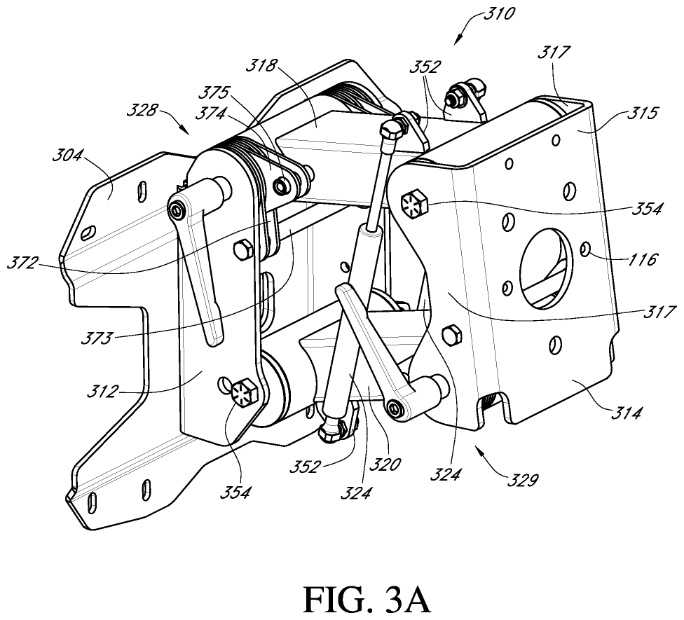

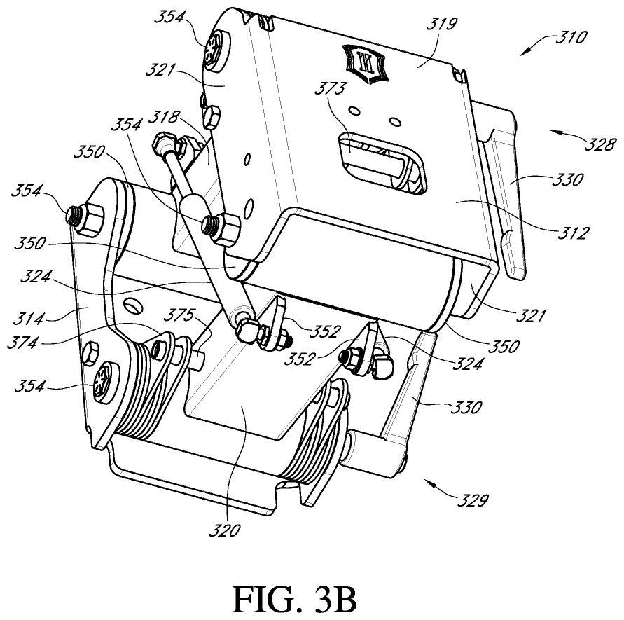

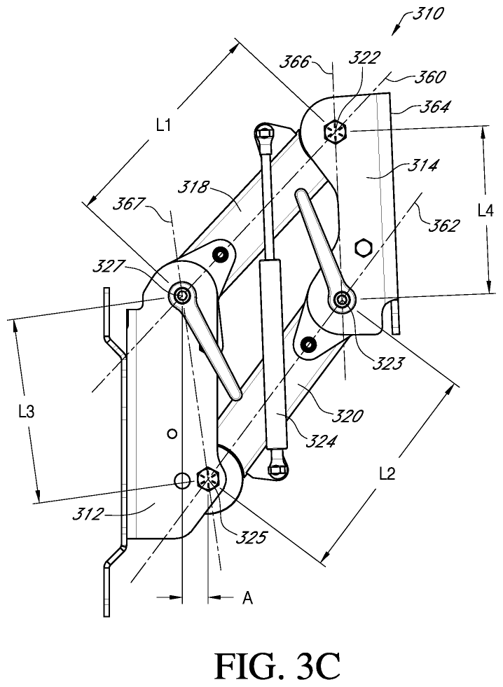

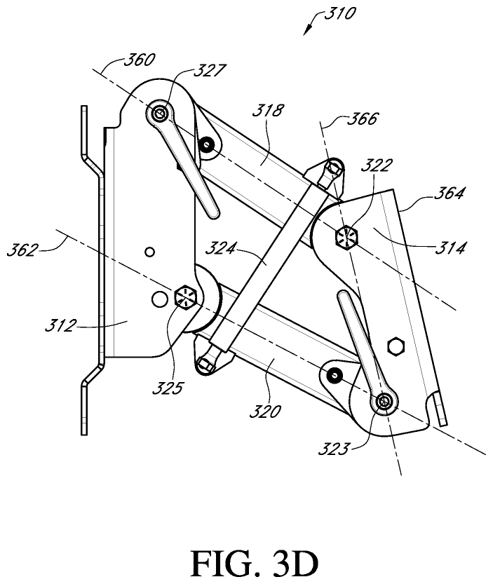

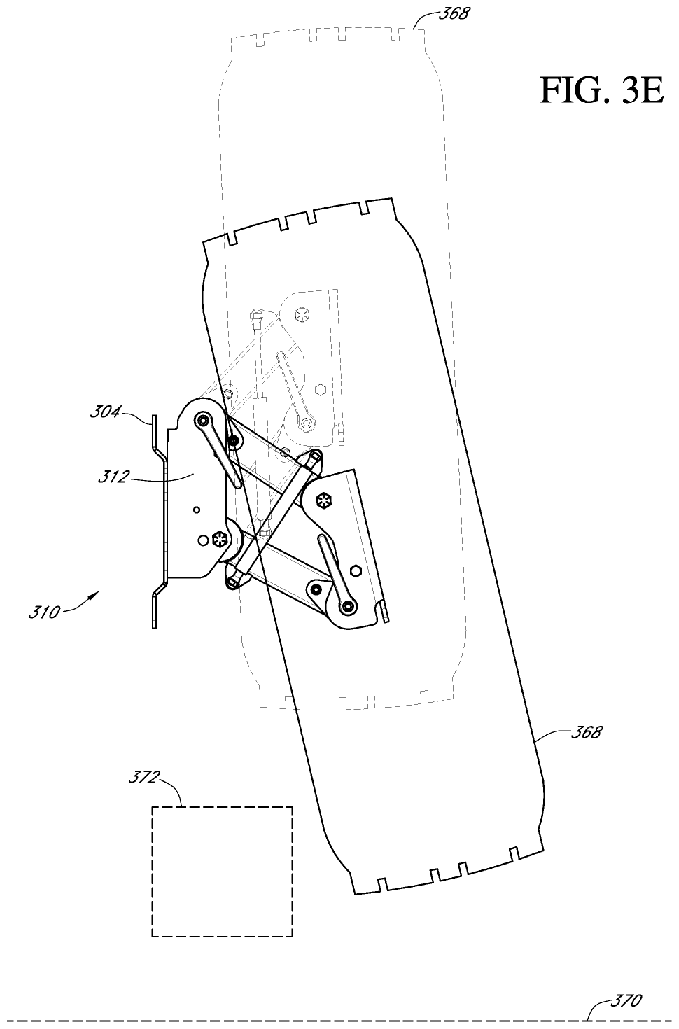

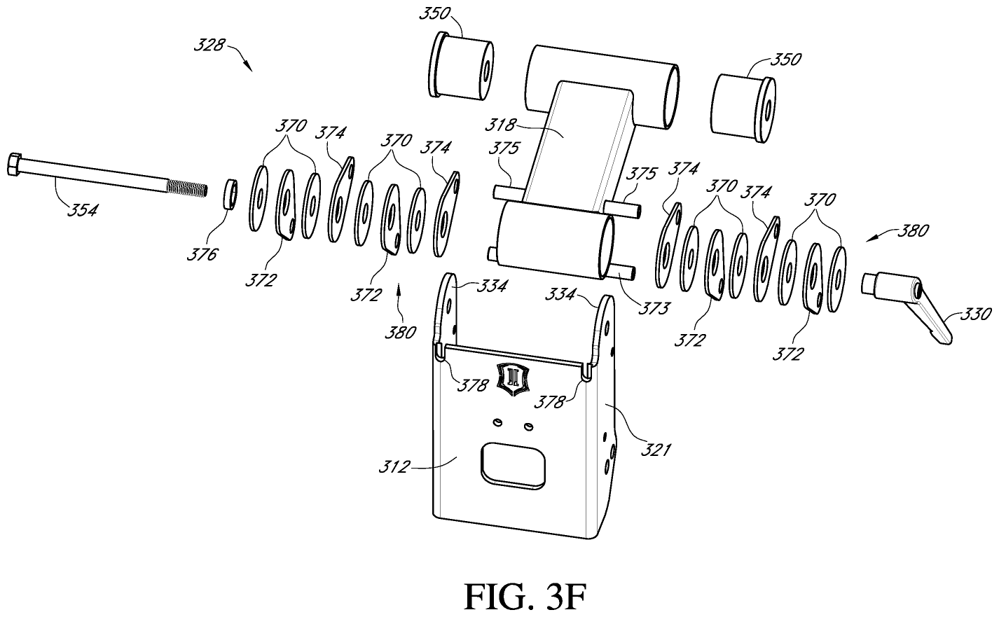

It should be noted that, although this embodiment illustrates an adjustable tire carrier that is attached to a bumper, the concepts disclosed herein may also be used in adjustable tire carriers that are not attached to a bumper, such as an adjustable tire carrier that is directly attached to a back wall or door of a vehicle or the like. For example, the adjustable tire carrier 110 may be modified to attach to a vehicle using the mounting bracket 304 shown in FIG. 3A, instead of arm 104.

With continued reference to FIG. 1A, the adjustable tire carrier 110 comprises a back or stationary portion 112 and a front or adjustable portion 114. The stationary portion 112 is attached to and intended to remain stationary with respect to the arm 104 (although the stationary portion 112 may be movable with respect to the vehicle, such as when the arm 104 pivots outward for a user to access the rear of the vehicle). The adjustable portion 114 is configured for a spare tire to be mounted thereto. For example, the adjustable portion 114 comprises a plurality of holes or other mounting features 116 for use in mounting a spare tire thereto. The adjustable portion 114 is further configured to be able to move with respect to the stationary portion 112, to enable the spare tire that is mounted thereto to be repositioned with respect to the vehicle (similarly to as illustrated in the schematic diagrams of FIGS. 2A and 2B). The stationary and adjustable portions 112, 114 may alternatively be referred to as brackets, housings, mounting members, u-shaped structures, and/or the like. Further details of the adjustable tire carrier 110 are given below with reference to FIGS. 1B, 1C, and 1D.

FIG. 1B illustrates a detail view of the adjustable tire carrier 110 of FIG. 1A. With reference to FIG. 1B, the adjustable tire carrier 110 further comprises two linkages, such as upper link 118 and lower link 120, that pivotally couple the adjustable portion 114 to the stationary portion 112. In this embodiment, the upper and lower links 118, 120 each rotate about pivot axes 122 positioned at first and second ends of each of the links. This configuration creates a four-bar linkage arrangement comprising the following four linkages: upper link 118, lower link 120, stationary portion 112, and adjustable portion 114. For simplicity in illustrating the present embodiment, FIG. 1B does not illustrate certain fasteners, such as bolts passing through the assembly at the pivot axes 122 or bolts attaching the biasing members 124 to the upper link 118 and stationary portion 112. Such components may be included, however, and may be similar to the bolts illustrated in the embodiment shown in FIGS. 3A-3F, described below. Further, the upper and lower links 118, 120 may utilize bearings, bushings, and/or the like, to reduce friction and/or control the pivoting motion of the upper and lower links 118, 120 with respect to the adjustable and stationary portions 114, 112. For example, bushings similar to the bushings 350 illustrated in FIG. 3F may be used.

In the embodiment of FIG. 1B, the linkages are arranged such that one linkage is above the other linkage and the two linkages 118, 120 are substantially parallel to one another. Such a configuration can allow the adjustable portion 114, and thus the spare tire coupled thereto, to remain in a substantially vertical orientation as it is adjusted upward or downward with respect to the stationary portion 112. In some embodiments, however, it may be desirable for the upper and lower links 118, 120 to not be parallel to one another. In such a configuration, the spare tire and adjustable portion 114 may experience some forward and/or backward tilting or rotation as the tire and adjustable portion 114 are moved up and down, which may be desirable in some cases. Such an embodiment is illustrated in FIGS. 3A-3F, described below.

The adjustable tire carrier 110 further comprises two biasing members 124 (see FIG. 1D) that are configured to bias the adjustable portion 114, and thus any tire coupled thereto, toward a raised position. Such a feature can be beneficial, for example, to assist a user in raising a spare tire, which can be relatively heavy. In this embodiment, the adjustable tire carrier 110 comprises two biasing members 124, which are pivotally attached at a first end to a lower portion of the stationary portion 112, and that are pivotally coupled to the upper link 118 at an upper end. Further, in this embodiment, the biasing members 124 are desirably gas struts or gas springs. Various other biasing configurations may be utilized, however. For example, only one biasing member may be used, or more than two biasing members may be used. As another example, the biasing members may be attached to different structures, as long as the two ends of the biasing members are attached to components that are intended to move with respect to one another. Further, a torsion spring may be utilized instead of or in addition to a longitudinal biasing member such as a gas spring. Some embodiments may not utilize a biasing member, however. In some embodiments, a damping feature is included, either as part of the biasing member(s) or as a separate component, to damp movement caused by the biasing member(s).

It can also be desirable for the adjustable portion 114 to be selectively lockable in one or more positions or orientations with respect to the stationary portion 112. For example, it may be desirable to at least allow the adjustable portion 114 to be locked in place in a fully raised position and/or a fully lowered position with respect to the stationary portion 112. In some embodiments, it can be desirable to also allow the adjustable portion 114 to be locked in one or more intermediate positions (i.e. raised or lowered positions between the fully raised and fully lowered positions) with respect to the stationary portion 112. Such a feature may be desirable, for example, because different vehicle configurations, different use cases, and/or different spare tire sizes may have different optimal raised and lowered positions. For example, if two spare tires are considered, with one being larger than the other, it may be desirable for the adjustable portion 114 to not be set as high in the raised position for the smaller tire as it would be for the larger tire. This is because, for example, the smaller tire may not need to be raised as high to have the same departure angle benefits, but it may also be desirable to not overly raise the spare tire, which could lead to a higher center of gravity of the vehicle.

To enable selective locking of the adjustable portion 114 with respect to the stationary portion 112, the embodiment illustrated in FIG. 1D comprises a locking assembly 128. The locking assembly 128 comprises a handle 130 that is coupled to a pin 132, which can be inserted into and engage one or more holes in a flange 134 that is connected to (and/or rotationally restrained with respect to) the lower link 120. Desirably, the handle 130 and pin 132 are held stationary with respect to the stationary portion 112, with the exception of being able to translate along the axis of the pin 132 when desired (and desirably being spring-loaded to bias the pin 132 toward the flange 134). Further, the flange 134 is desirably attached to the lower link 120 in a manner that it remains stationary with respect to the lower link 120. Accordingly, when the pin 132 engages a hole of the flange 134, the lower link 120 will desirably remain stationary with respect to the stationary portion 112, thus also causing the adjustable portion 114, and any tire attached thereto, to remain stationary with respect to the stationary portion 112.

Although this embodiment illustrates one specific example of a locking assembly 128, various other methods of selectively locking the movement of the adjustable portion 114 with respect to the stationary portion 112 may be used. For example, a similar locking assembly may be used, but positioned anywhere else on the adjustable tire carrier 110, as long as the pin 132 is able to be held stationary with respect to a first component that is movable with respect to a second component that comprises one or more holes (such as similar to the holes shown here in flange 134). As another example, the assembly may be modified to selectively lock in place using tension or torque from one or more threaded fasteners (such as, for example, the locking assembly 328 illustrated in FIG. 3F, which also includes clutch packs 380 to amplify the holding power of the tension force created by bolt 354 and threaded handle 330).

Although the embodiment illustrated in FIGS. 1A-1D is intended to be manually operated, one or more electronically or hydraulically operated features may be included. For example, the manual locking assembly 128 may in some embodiments be operated electronically, such as using a solenoid or the like. Further, upward and downward movement of the adjustable portion 114 with respect to the stationary portion 112 may be electronically, hydraulically, and/or pneumatically controlled, such as by using a motor, a hydraulic system, a pneumatic system, and/or the like.

FIGS. 1C and 1D further illustrate that the adjustable and stationary portions 114, 112 are both in this embodiment formed by a front wall or back wall 115, 119 that is connected on either side to a pair of sidewalls 117, 121. In this embodiment, such a configuration creates an interior space or cavity between the sidewalls 117, 121 within which the ends of the upper and lower links 118, 120 are positioned. Such a design can allow for a relatively compact yet robust design that can also have a reduced weight over some alternative designs.

### ADDITIONAL ADJUSTABLE TIRE CARRIER EXAMPLE

FIGS. 3A-3F illustrate another embodiment of an adjustable tire carrier 310. FIG. 3A illustrates a front perspective view of the adjustable tire carrier 310, FIG. 3B illustrates a back perspective view of the adjustable tire carrier 310, FIG. 3C illustrates a side view of the adjustable tire carrier 310 in a raised position, FIG. 3D illustrates a side view of the adjustable tire carrier 310 in a lowered position, FIG. 3E illustrates a side view of the adjustable tire carrier in both raised and lowered positions with a tire attached thereto, and FIG. 3F illustrates details of a locking assembly 328 of the adjustable tire carrier 310. The adjustable tire carrier 310 has many similarities to the adjustable tire carrier 110 described above, and like reference numbers are used to refer to like components.

With reference to FIGS. 3A and 3B, similar to the adjustable tire carrier 110, the adjustable tire carrier 310 comprises a back or stationary portion 312, a front or adjustable portion 314, and upper and lower links 318, 320 that enable the adjustable portion 314 to move with respect to the stationary portion 312. Further, similar to the adjustable tire carrier 110, the stationary portion 312, adjustable portion 314, upper link 318, and lower link 320 are pivotally coupled to one another in a four bar linkage arrangement. One difference from the embodiment illustrated in FIG. 1A is that the stationary portion 312 of the adjustable tire carrier 310 is attached to a mounting bracket 304 instead of a rotating arm 104. The mounting bracket 304 may be configured to, for example, attach to a rear portion of a vehicle, such as a rear door, a trunk, a truck tailgate, and/or the like. Although the drawings illustrate the adjustable tire carrier 310 being attached to a mounting bracket 304, and the adjustable tire carrier 110 being attached to a rotating arm 104, either adjustable tire carrier 110, 310 may be configured to be used with the mounting bracket 304, the rotating arm 104, or any other variation of a structure that is able to mount the stationary portion 112, 312 to a vehicle. In some embodiments, the stationary portion 112 or 312 may even be directly attached to a portion of a vehicle instead of being attached to the vehicle through a mounting bracket, arm, and/or the like.

In this embodiment, the stationary and adjustable portions 312, 314 each desirably comprise a generally U-shaped structure that comprises a front or back wall 315, 319 that has opposing side walls or flanges 317, 321 extending therefrom at a generally right angle. Other designs may be utilized, but using such a U-shaped structure can be desirable from a rigidity and/or compactness perspective.

The adjustable tire carrier 310 further comprises two biasing members 324, which in this embodiment are desirably gas springs or gas struts. Other embodiments may utilize different types of biasing members, such as a mechanical compression spring and/or tension spring, a rotational spring, and/or the like, and may include one or more damping mechanisms. Gas springs can be beneficial, however, because they can be relatively compact for the amount of force they can exert, they can be relatively robust in harsh environments, and they desirably include damping features to help control the motion of the adjustable portion 314.

In the embodiment shown in FIGS. 3A and 3B, the biasing members 324 are coupled to the upper and lower links 318, 320 at flanges 352 that extend above the top surface of the upper link 318 and below the bottom surface of the lower link 320. Attaching the ends of the biasing members 324 to the flanges 352 instead of directly to the main body of the upper and lower links 318, 320 can be beneficial, for example, because it can allow the total stroke of the gas springs from the fully raised position to the fully lowered position (see FIGS. 3C and 3D) to be greater than if the ends of the gas springs 324 were connected directly to the main body of the upper and lower links 318, 320. By extending the stroke of the gas springs 324, a more controlled motion can be achieved. That said, various other embodiments may attach the biasing members 324 at various other locations. For example, the upper ends of the biasing members 324 may be coupled to the upper link 318, and the lower ends of the biasing members 324 may be coupled to the stationary member 312. As another example, the upper ends of the biasing members 324 may be connected to the adjustable portion 314, and the lower ends of the biasing members 324 may be connected to the lower link 320 or stationary portion 312. Although the configuration illustrated in FIGS. 3A-3D may be beneficial, other embodiments could have the two ends of the biasing members 324 attached to any two portions of the adjustable tire carrier 310 that are movable with respect to one another.

With continued reference to FIGS. 3A and 3B, the four linkages of the four bar linkage mechanism, namely the stationary portion 312, adjustable portion 314, upper link 318, and lower link 320, are pivotally coupled together at pivot axes defined by four bolts 354. Each of the four bolts 354 defines a separate pivot axis 322, 323, 325, or 327, as shown in FIGS. 3C and 3D. In the embodiment of FIGS. 3A and 3B, a plurality of bushings 350 are desirably used between the links 318, 320 and the bolts 354 to constrain the motion of the components to be a pivotal motion with relatively low friction and desirably little to no motion in any direction other than pivoting motion about the pivot axes defined by the bolts 354. The bushings 350 may comprise an acetal material, a DELRIN® material, bronze, or any other suitable bushing material. In other embodiments, one or more bearings may be used instead of or in addition to bushings, or no bushings or bearings may be used. Although bolts are used in this embodiment to define the pivot axes, other embodiments may use other types of shafts, axles, and/or the like to define the pivot axes.

Another difference in the adjustable tire carrier 310 with respect to adjustable tire carrier 110 is how the adjustable tire carrier 310 is configured to lock in a particular orientation. The adjustable tire carrier 110 includes a pin lock arrangement 128 that is able to lock the adjustable portion 114 in a particular orientation with respect to the stationary portion 112 (see FIG. 1D and the above discussion). The adjustable tire carrier 310, on the other hand, utilizes clutch type locking assemblies in order to lock the adjustable portion 314 in a particular orientation with respect to the stationary portion 312. Specifically, the adjustable tire carrier 310 comprises one locking assembly 328 that is configured to selectively lock the upper link 318 with respect to the stationary portion 312, and a second locking assembly 329 that is configured to selectively lock movement of the adjustable portion 314 with respect to the lower link 320. Additional details of the locking assemblies 328, 329 are described below with reference to FIG. 3F.

Although in this embodiment two separate locking assemblies 328, 329 are utilized, other embodiments may utilize fewer or more locking assemblies. For example, either of the locking assemblies 328 or 329 may be utilized on its own, the positions of the locking assemblies 328, 329 may be different, such as by moving locking assembly 328 down to the pivot bolt 354 that connects the stationary portion 312 to the lower link 320, moving the locking assembly 329 up to the pivot bolt 354 that connects the adjustable portion 314 to the upper link 318, and/or the like. As another example, additional locking assembly similar to the locking assemblies 328 and 329 may be incorporated into either or both of the other pivot axes of the four bar linkage, leading to a total of three or four locking assemblies in some embodiments.

In an ideal theoretical four bar linkage arrangement, locking any one of the four members with respect to another of the four members may cause the entire assembly to be locked, with no relative motion between any of the four members being allowed. In practice, however, various features of a four bar linkage, such as the four bar linkage designs disclosed herein, may lead to at least some relative motion between two or more of the members of the four bar linkage system when only one member is constrained with respect to a second. For example, there may be some radial clearance between the bushings 350 and the bolts 354, there may be some longitudinal clearance between the inside surfaces of the sidewalls 317, 321 and the bushings 350 and/or other components of the assembly, and/or the like. Even if such clearances are relatively small, they could lead to undesirable motion, vibrations, rattling, and/or the like if only one member of the four bar linkage arrangement is locked with respect to a second member of the four bar linkage arrangement (and/or if only pivotal motion is locked, without also constraining longitudinal motion), particularly in an assembly that is intended to be attached to a vehicle that is traversing off-road terrain and would likely experience significant shock, impact, and/or vibrations from the terrain. Accordingly, it can be beneficial to utilize an arrangement such as the arrangement illustrated in FIGS. 3A-3F, which comprises two locking assemblies 328, 329 that restrain pivotal motion at two of the four axes, and that also restrain longitudinal motion at those axes.

Turning now to FIGS. 3C and 3D, these figures illustrate a side view of the adjustable tire carrier 310, with the adjustable portion 314 in a raised position (FIG. 3C) and a lowered position (FIG. 3D). In these views, the raised position is the fully raised position, and the lowered position is the fully lowered position. Various embodiments may utilize one or more stroke limiting features that define the fully raised position and fully lowered position (e.g., the positions in which the adjustable portion 314 is not able to be moved further upward in the fully raised position or further downward in the fully lowered position). For example, the biasing members 324, which in this case comprise gas struts, may have internal stroke limiting features which will also limit the stroke of the complete assembly. As another example, one or more different components of the adjustable tire carrier assembly may be configured to contact one another at a fully raised and/or fully lowered position to prohibit further movement. For example, in some embodiments, the shaft 373 shown in FIG. 3A may be positioned such that it comes into contact with the lower link 320 in the fully raised position and/or the upper link 318 in the fully lowered position.

One beneficial feature of the adjustable tire carrier 310 is that the orientation of the adjustable portion 314 with respect to a horizontal reference plane (such as a horizontal surface the vehicle is resting on) can vary between the raised position and the lowered position. This can be desirable, for example, because it can enable the spare tire that is attached to the adjustable portion 314 to be angled differently in the raised and lowered positions. For example, with reference to FIG. 3E, FIG. 3E illustrates the same raised and lowered positions of FIGS. 3C and 3D, but with the two views overlaid on top of one another and a spare tire 368 attached to the adjustable portion 314. As can be seen in FIG. 3E, in the raised position, the spare tire 368 is oriented relatively close to perpendicular to a horizontal reference plane 370 (and/or relatively close to parallel to the mounting bracket 304 and/or a rear surface of the vehicle). In the lowered position, however, the spare tire 368 is further inclined with respect to the horizontal reference plane 370 such that a bottom portion of the tire 368 is positioned horizontally further away from the mounting bracket 304 than a top portion of the spare tire 368. Such a configuration may be desirable, for example, because when the spare tire 368 is lowered, there may be one or more obstructions 372 that would otherwise stop the spare tire 368 from being able to be lowered the desired amount. FIG. 3E illustrates a box 372 that is representative of one or more obstructions that might be present on a vehicle that need to be avoided by the spare tire 368 in the lowered position. The obstruction 372 may comprise, for example, a vehicle bumper, a tow hitch, and/or the like. In this embodiment, the amount of incline of the tire 368 (such as an angle of the outermost rear surface of the tire with respect to the horizontal plane 370 or a vertical plane) is equal to the amount of incline of a rear face 364 of the adjustable member 314 (and/or line 366 of FIG. 3D), since the rear face 364 (and/or line 366) is desirably parallel to the outermost rear surface of the tire 368. Other embodiments may not necessarily have this arrangement, however.

Returning to FIGS. 3C and 3D, these figures illustrate additional details that enable the four bar linkage arrangement of the adjustable tire carrier 310 to pivot the spare tire as shown in FIG. 3E. It should be noted that various lengths of linkages in the four bar arrangement and/or positioning of pivot axes in the four bar arrangement may be utilized to accomplish a particular desired range of motion and/or amount of pivoting of the tire. The embodiment illustrated in FIGS. 3C and 3D is merely one example and other arrangements could be utilized. Further, some embodiments may utilize a parallelogram type four bar linkage arrangement that desirably does not result in any pivoting of the tire 368 with respect to the horizontal reference plane 370.

With reference to FIG. 3C, this embodiment comprises four linkages that are pivotally coupled to one another, the four linkages comprising the stationary portion 312, the adjustable portion 314, the upper link 318, and the lower link 320. The linkages are pivotally coupled to one another at pivot axes 322, 323, 325, and 327, which are desirably defined by the bolts 354 (shown in FIGS. 3A and 3B), and which are desirably oriented parallel to one another and perpendicular to the plane of the drawing sheet for FIGS. 3C and 3D. Each of the four linkages comprises a length, which is defined as the distance between the two pivot axes for each linkage. For example, length L1 of the upper link 318 is defined as the distance between axes 327 and 322, length L2 of lower link 320 is defined as the distance between pivot axes 323 and 325, length L3 of the stationary portion 312 is defined as the distance between pivot axes 325 and 327, and length L4 of the adjustable portion 314 is defined as the distance between pivot axes 322 and 323. Each pair of pivot axes for each particular linkage of the four bar linkage system can also define a line that passes through the pair of pivot axes and that is parallel to the plane defined by the drawing sheet. For example, line 360 passes through pivot axes 322 and 327, line 362 passes through pivot axes 323 and 325, line 366 passes through pivot axes 322 and 323, and line 367 passes through pivot axes 325 and 327.

In various embodiments, the relative positions of the axes 322, 323, 325, 327, and the relative lengths of the links L1, L2, L3, L4 can be varied to result in a particular desired range of translational motion of the adjustable portion 314 (e.g., the translational distance in the vertical and/or horizontal directions between the raised and lowered positions) and a particular desired range of pivoting (e.g., the difference in angular orientation of the adjustable portion 314 with respect to the horizontal reference plane 370 in the raised and lowered positions). In the embodiment illustrated in FIGS. 3C and 3D, the illustrated translational and pivoting motion of the adjustable portion 314 is accomplished using the following approximate lengths of the linkages: L1=8.0 inches, L2=8.0 inches, L3=6.0 inches, and L4=6.625″. Further, in the present embodiment, lower pivot axis 325 of the stationary portion 312 is positioned approximately 0.9 inches outward or rearward of the upper pivot axis 327 of the stationary portion 312. This dimension is illustrated as dimension A in FIG. 3C. These example dimensions result in the relative positioning of the adjustable portion 314 with respect to the stationary portion 312 in the raised and lowered positions as illustrated in FIGS. 3C and 3D.

Other embodiments may utilize different dimensions and/or positioning of the pivot axes. For example, each of the linkage lengths may be greater or smaller than the examples given above, each of the linkage lengths may be within a range of, for example, 4 inches to 10 inches, and/or the like. Further, although the present embodiment utilizes upper and lower links 318, 320 that comprise the same lengths L1, L2, other embodiments may have one of the upper or lower links 318, 320 be longer than the other. Further, although this embodiment has length L3 of the stationary portion 312 as longer than length L4 of the adjustable portion 314, other embodiments may utilize the same lengths L3, L4 or may have length L4 be longer than length L3. In the embodiment of FIGS. 3C and 3D, a ratio of length L4 of the adjustable portion 314 to length L1 of upper link 318 is approximately 3/4. In some embodiments, this ratio may be approximately, no greater than, or no less than 1/4, 3/8, 1/2, 5/8, 3/4, 7/8, 1/1, 9/8, or 5/4.

With further reference to FIGS. 3C and 3D, it can be seen that lines 360 and 362 are desirably nonparallel to one another in both the raised position (FIG. 3C) and the lowered position (FIG. 3D). Further, lines 360 and 362 desirably remain nonparallel to one another throughout the entire stroke from the raised position to the lowered position. In some embodiments, however, the lines 360 and 362 may have at least some portion in the stroke from the raised position to the lowered position wherein they are parallel. For example, the assembly can be configured such that, at the raised position the lines 360 and 362 are nonparallel such that they intersect to the right of the view, at some point when moving from the raised position to the lowered position the lines 360 and 362 become parallel, and at the lowered position the lines 360 in 362 intersect to the left of the view. Further, in some embodiments, the lines 360 and 362 may be parallel at the raised or lowered position, but nonparallel at all other positions. Further, some embodiments may have lines 360 and 362 be parallel to one another throughout the entire range of motion. In such an embodiment, however, the tire 368 would not pivot with respect to the horizontal reference plane 370 throughout the range of motion, which may be acceptable or even preferable in some use cases.

In some embodiments, the adjustable tire carrier 310 is configured such that line 366 is at or close to vertical in the raised position (e.g. FIG. 3C) (such as being inclined no more than 5° or no more than 10°), and inclined with respect to vertical by at least 10° in the lowered position (e.g. FIG. 3D). In some embodiments, line 366 is inclined with respect to vertical in the raised position within a range of 0° to 5° or 5° to 10°, and line 366 is inclined with respect to vertical in the lowered position within a range of 5° to 15° or 10° to 20°. In the embodiment of FIGS. 3C-3E, these example angles for line 366 also correspond to the orientation of the rearmost surface of the tire 368, since desirably line 366 is parallel to the rearmost surface of the tire 368. In an embodiment where the rearmost surface of the tire 368 is not parallel to line 366, the specific angles and ranges given above can be considered to apply to the rearmost surface of the tire instead of line 366.

Turning now to FIG. 3F, FIG. 3F illustrates an exploded view of locking assembly 328 of the adjustable tire carrier 310 illustrated in FIG. 3A. For clarity, the exploded view of FIG. 3F illustrates only one of the two locking assembly 328, 329, and other components unrelated to the locking assembly 328 have been hidden. The second locking assembly 329 (shown in FIGS. 3A and 3B) can be of a similar or identical design to the locking assembly 328 illustrated in FIG. 3F and described herein.

The locking assembly 328 comprises two clutch packs 380, with one positioned on either side of the upper link 318 and within a void between the upper link 318 and upper flanges 334 of the sidewalls 321 of the stationary portion 312. Each of the clutch packs 380 comprises a plurality of coaxially aligned clutch plates 372, 374 and clutch washers 370. The clutch plates 372 are configured to be rotationally constrained with respect to the stationary portion 312, and the clutch plates 374 are configured to be rotationally restrained with respect to the upper link 318. Accordingly, when the locking assembly 328 is activated, restraining relative rotation between clutch plates 372 and clutch plates 374 about the pivot axis defined by bolt 354, pivoting motion of the upper link 318 about the axis defined by bolt 354 is also restrained with respect to the stationary portion 312. As further described below, activating the locking assembly 328 by clamping the flanges 334 will also desirably limit longitudinal translation of the upper link 318 with respect to the stationary portion 312 along the axis defined by bolt 354.

In this embodiment, each clutch pack 380 comprises two clutch plates 374, two clutch plates 372, and four clutch washers 370. Other embodiments may use a different number of clutch plates and washers, including fewer or more. Desirably, the clutch plates 372, 374 comprise a metal or other relatively strong and/or stiff material, and the clutch washers 370 comprise a material that is configured to increase the friction between the clutch plates 372, 374 to an amount that would be higher than if the clutch plates 372, 374 were merely clamped together against each other without any clutch washers 370. Other embodiments may utilize other arrangements, for example, such as not including any clutch washers 370, incorporating friction material into the mating surfaces of the clutch plates 372, 374 to take the place of the clutch washers 370, and/or the like. In some embodiments, the clutch washers 370 (and/or the clutch plates 372, 374) comprise a friction material typical of mechanical clutch designs, such as organic, KEVLAR®, ceramic, FERAMIC®, FeramAlloy, and/or the like friction material.

In this embodiment, the clutch washers 370 comprise an outer diameter of approximately 2.5 inches and an inner diameter (corresponding to the hole through which the bolt 354 passes) of approximately 0.76 inches. Other embodiments may use different sizes, such as an outer diameter within a range of 2.0-3.0 inches, 1.5-2.5 inches, and/or the like. By using eight total clutch washers 370 in the locking assembly 328, the clamping surface area can be increased significantly over a design that uses fewer clutch washers (or does not even in include clutch components). In an embodiment that utilizes an outer diameter of approximately 2.5 inches, and an inner diameter of approximately 0.76 inches, each side of a clutch washer 370 has approximately 4.46 in² of surface area. Accordingly, if eight clutch washers 370 are used, there is approximately 71.36 in² of total surface area available to magnify the rotational static friction force generated by the clamping together of the flanges 334 by the bolt 354 and threaded handle 330. In some embodiments, the total surface area of the clutch washers 370 is at least 25, 50, or 75 in². In some embodiments, the total surface area of the clutch washers 370 is within a range of 25-50, 50-75, or 75-100 in².

In this embodiment, the clutch plates 372 and 374 desirably comprise a generally teardrop shaped outer perimeter, with a portion of the plate being shaped to contact a face of a clutch washer 370, and a portion of the plate extending laterally outward to engage an anti-rotate feature. For example, the clutch plates 374 are desirably restrained from rotation with respect to the upper link 318 by protrusions 375 that protrude from the main body of upper link 318 and pass through corresponding openings in the clutch plates 374, as can be seen in the installed position illustrated in FIG. 3A. Further, the clutch plates 372 are desirably restrained from rotation with respect to the stationary portion 312 by a shaft 373 that passes through corresponding openings in the clutch plates 372, and that is desirably affixed to the stationary portion 312, such as by using fasteners, welding, and/or the like, as can be seen in the installed position illustrated in FIG. 3A. In other embodiments, the clutch plates 372, 374 may be restrained from rotation with respect to the stationary portion 312 or upper link 318 using different anti-rotate features.

When the locking assembly 328 is assembled, the shaft of the bolt 354 desirably passes through each of the clutch packs 380, the flanges 334, an end of the upper link 318, and into a threaded aperture of handle 330. When a user desires to lock the upper link 318 in a particular orientation with respect to stationary portion 312, the user can rotate the handle 330 which, due to the threads on the end of the bolt 354 and the threaded aperture of the handle 330, will desirably cause the flanges 334 of the stationary portion 312 to compress toward one another, thus also compressing both of the clutch packs 380. In such a configuration, the higher the clamping force provided by the bolt 354 and handle 330, the higher the static rotational friction force that will be created within the clutch packs 380.

In some embodiments, such as the embodiment illustrated in FIG. 3F, the stationary portion 312 comprises a void, groove, or slot 378 adjacent each of the flanges 334. In a stationary portion 312 that comprises a U-shaped structure, such as the stationary portion 312 illustrated in FIG. 3F, such voids 378 can help to increase the inward flexibility of the flanges 334 to assist in operating the locking assembly 328. For example, if the voids 378 were not included, the resistance to bending of the flanges 334 would be higher, thus resulting in more of the clamping force provided by the bolt 354 and handle 330 going toward bending the flanges 334 instead of clamping together the clutch packs 380. Although such voids 378 may be desirable, they are not required.

To enhance usability and/or convenience of the locking assembly 328 operation, the locking assembly 328 further comprises a bolt anti-rotate component 376. For example, the bolt anti-rotate component 376 may comprise an interior surface configured to mate with the head of the bolt 354 and keep the bolt 354 from rotating when a user rotates the handle 330, without requiring the user to otherwise anti-rotate the bolt 354, such as by using a wrench on the head of the bolt 354. The anti-rotate component 376 may be formed as an integral part of the flange 334 of the stationary portion 312, the anti-rotate component 376 may be attached to the flange 334, such as through welding, other fastening means, and/or the like.

FIG. 3F further illustrates an exploded view of two of the bushings 350 that can be positioned functionally between a portion of the upper link 318 and pivot bolt 354. Although the bushings 350 in this view are only illustrated for the second end of the upper link 318 (the end that does not include the locking assembly 228), the same or similar bushings 350 may be used at each of the four pivot axes 322, 323, 325, 327.

One advantage of a locking assembly such as the locking assembly 328 illustrated in FIG. 3F is that the use of clutch packs 380 allows a relatively small clamping force provided by the handle 330 and bolt 354 to be converted into a relatively large static friction force that prevents rotation of the upper link 318 with respect to stationary portion 312 (or a different pair of components, if the locking assembly is positioned at a different pivot axis). Other embodiments may not use such clutch packs 380, however, and may for example clamp the flanges 334 of the stationary portion 312 directly onto the link 318 or some component or components positioned therebetween, such as a washer, bushing, and/or the like.

Another advantage of a locking assembly such as the locking assembly 328 illustrated in FIG. 3F is that the adjustable portion 314 of the adjustable tire carrier 310 can desirably be locked in any position with respect to the stationary portion 312, including the fully raised position, the fully lowered position, and any position therebetween. This may be desirable from a user experience standpoint, because different use cases may call for positioning the spare tire differently, which may not necessarily be at the fully raised or fully lowered position. Although the locking assembly 328 is desirably configured such that the locked position is infinitely adjustable (meaning the system can be locked in any position, including the fully raised position, the fully lowered position, and any position therebetween), other embodiments may utilize different locking assemblies that have specific predefined positions the assembly can be locked into. For instance, the adjustable tire carrier 110 illustrated in FIG. 1D illustrates such an arrangement, where the positions the carrier can be locked in depend on the position and relative spacing of the holes of flange 134. Variations of the design illustrated in FIG. 3F may, however, also provide an assembly that only locks into specific predefined positions. For example, the clutch plates 374, 372 may comprise complementary ridged or otherwise textured surfaces that mate together in a complementary fashion at specific rotational orientations with respect to one another. Such a design may be desirable, for example, because it could provide a relatively strong rotational lock, potentially with less overall components needed than the present clutch packs 380, while also potentially allowing for more adjustability than a pin lock type system, like the system illustrated in FIG. 1D.

Another benefit of the arrangement of the locking assembly 328 is that, in addition to preventing rotation about bolt 354 of the upper link 318 with respect to stationary portion 312, the clamping together of the flanges 334 also desirably removes any slop or longitudinal movement along the pivot axis direction that the upper link 318 may normally have with respect to the stationary portion 312 when the locking assembly 328 is not locked. Accordingly, by restraining both rotational and longitudinal movement of the upper link 318 with respect to the stationary portion 312 (and/or of any other pair of components of the four bar linkage arrangement), a robust locking mechanism is provided that can desirably stand up to the rigors of use experienced in off-road environments.

Although the embodiment illustrated in FIG. 3F illustrates a threaded handle 330 used to lock or unlock the locking assembly 328 (e.g., by clamping or un-clamping the flanges 334 against the clutch packs 380), various other actuation mechanisms may be used. For example, instead of a threaded handle engaging a thread of bolt 354, the handle 330 may comprise a cam lock mechanism that connects to an end of the bolt 354 (or a similarly sized shaft) and, for example, causes the flanges 334 to clamp together or unclamp in response to the handle and associated cam mechanism pivoting. As another example, the locking assembly 328 may be configured to electronically lock or unlock, such as by including a solenoid or other electronically activated component that clamps or unclamp the flanges 334 and/or clutch packs 380 together. Further, although the embodiment of an adjustable tire carrier 310 illustrated in FIGS. 3A-3F includes two similar but independently operatable locking assemblies 328, 329, in some embodiments, the assembly may be configured such that locking or unlocking of a single locking assembly also causes the other or others to lock or unlock. For example, the two handles 330 of the two locking assembly 328, 329 may be configured such that a linkage between the two handles 330 causes movement of one handle 330 to also move the other handle 330. In such an embodiment, one of the handles 330 may not technically be a “handle” and may not comprise a protruding member that is configured for a human hand to manipulate, but rather may comprise a flange or similar that is configured to be pivotally coupled to a linkage that connects the driving handle to the driven “handle.”

### ADDITIONAL EMBODIMENTS

FIGS. 1A-1D and 3A-3F depict two embodiments of adjustable tire carriers embodying the concepts disclosed herein. In addition to alternative configurations described above, other alternative embodiments may also embody the concepts disclosed herein. For example, although the embodiments illustrated in FIGS. 1B and 3A each comprise a four bar linkage arrangement, other embodiments may comprise a linkage arrangement with additional linkages (such as to achieve a more complex motion) or an arrangement that does not utilize linkages. For example, the adjustable portions 114, 314 may be configured to slide or translate in a single direction with respect to the stationary portions 112, 312 (e.g., in a substantially vertical direction or a direction slightly inclined with respect to vertical, such as no more than 5, 10, or 15 degrees) instead of moving with respect to the stationary portion 112, 312 in a movement that comprises both vertical and horizontal translational motion and/or rotational motion. For example, the adjustable portion 114, 314 may be configured to slide up and down with respect to the stationary portion 112, 312, with a lead screw, such as an acme screw or ball screw, causing the sliding movement. As another example, the adjustable portion 114, 314 may be configured to slide up and down with respect to the stationary portion 112, 312, but without any actuation member like a lead screw causing the sliding movement. For example, the adjustable portion 114, 314 may simply be moved up and down by hand (with or without the help of a biasing member). As another example, in some embodiments, the adjustable portion 114, 314 may be configured to rotate with respect to the stationary portion 112, 312, with or without any translational movement.

Additionally, various other types of locking arrangements may be utilized. For example, instead of using clutch packs that clamp longitudinally together in order to increase a static rotational friction force, a similar mechanism (e.g., longitudinal clamping to resist rotational motion) may be used but without clutch packs. As another example, an adjustable tire carrier may utilize a lead screw or ball screw to cause raising or lowering of the adjustable portion 114, 314, and that lead screw or ball screw may be of such a design that it is self-locking, and thus maintains the adjustable portion 114, 314 in a particular orientation, or a separate locking device may be used to lock the lead screw or ball screw in a particular orientation, thus also causing the adjustable portion 114, 314 to be locked into a particular orientation.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present inventions herein disclosed should not be limited by the particular disclosed embodiments described above.

What is claimed is:

1. An adjustable tire carrier, comprising:
a first member configured to be attached to a vehicle;
a second member configured to have a spare tire attached thereto;
a first arm having a first end pivotally coupled to the first member at a first pivot axis, and a second end pivotally coupled to the second member at a second pivot axis;
a second arm having a first end pivotally coupled to the first member at a third pivot axis, and a second end pivotally coupled to the second member at a fourth pivot axis,
wherein the first arm and the second arm are configured to enable the second member to move with respect to the first member between a raised position and a lowered position;
one or more biasing member configured to bias the second member toward the raised position; and
a clutch mechanism configured to selectively lock the second member in at least the raised position or the lowered position,
wherein the clutch mechanism comprises:
a plurality of clutch plates comprising one or more first clutch plates that are rotationally constrained with respect to one of the first member or the second member, and one or more second clutch plates that are rotationally constrained with respect to one of the first arm or the second arm; and
a movable handle configured to selectively apply a longitudinal clamping force to the plurality of clutch plates to resist rotation of the one or more first clutch plates with respect to the one or more second clutch plates.

2. The adjustable tire carrier of claim 1, wherein the one of the first member or the second member comprises a first flange and a second flange that are spaced apart and form a space therebetween, with the plurality of clutch plates being positioned between the first flange and the second flange, and the adjustable tire carrier further comprises:
a shaft that defines one of the first, second, third, or fourth pivot axes, the shaft having a first end and a second end, wherein the shaft passes through the first flange, the second flange, and the plurality of clutch plates, and
wherein the movable handle is configured to selectively apply the longitudinal clamping force by clamping the first flange and the second flange between the first end of the shaft and the handle such that the first flange and the second flange deflect inwardly toward the plurality of clutch plates.

3. The adjustable tire carrier of claim 2, wherein the second end of the shaft is threaded, and the moveable handle comprises a thread that engages the threaded second end of the shaft.

4. The adjustable tire carrier of claim 1, wherein the clutch mechanism further comprises a plurality of clutch washers interposed between the plurality of clutch plates.

5. The adjustable tire carrier of claim 1, wherein the one or more first clutch plates are rotationally constrained with respect to the first member, the one or more second clutch plates are rotationally constrained with respect to the first arm, and the adjustable tire carrier further comprises:
a second clutch mechanism comprising:
a plurality of clutch plates comprising one or more third clutch plates that are rotationally constrained with respect to the second member, and one or more fourth clutch plates that are rotationally constrained with respect to the second arm; and
a second movable handle configured to selectively apply a longitudinal clamping force to the plurality of clutch plates of the second clutch mechanism to resist rotation of the one or more third clutch plates with respect to the one or more fourth clutch plates.

6. The adjustable tire carrier of claim 1, wherein the first member comprises a u-shaped bracket comprising a left sidewall and a right sidewall that form a space therebetween, and the first end of one or both of the first and second arms is positioned within the space formed between the left and right sidewalls.

7. The adjustable tire carrier of claim 6, wherein the second member comprises a u-shaped bracket comprising a left sidewall and a right sidewall that form a space therebetween, and the second end of one or both of the first and second arms is positioned within the space formed between the left and right sidewalls of the second member.

8. The adjustable tire carrier of claim 1, wherein the first pivot axis and the second pivot axis define a first line that passes through and is perpendicular to both of the first pivot axis and the second pivot axis, the third pivot axis and the fourth pivot axis define a second line that passes through and is perpendicular to both of the third pivot axis and the fourth pivot axis, and the second line is non-parallel to the first line when the second member is in at least one of the raised position or the lowered positon.

9. The adjustable tire carrier of claim 8, wherein the second pivot axis and the fourth pivot axis define a third line that passes through and is perpendicular to both of the second pivot axis and the fourth pivot axis, and the third line is oriented at different angles with respect to a horizontal reference when the second member is in the raised position and when the second member is in the lowered position.

10. The adjustable tire carrier of claim 1, wherein the one or more biasing members comprises a gas strut.

11. The adjustable tire carrier of claim 10, wherein:
the first arm is positioned above the second arm,
the first pivot axis and the second pivot axis define a first line that passes through and is perpendicular to both of the first pivot axis and the second pivot axis,
the third pivot axis and the fourth pivot axis define a second line that passes through and is perpendicular to both of the third pivot axis and the fourth pivot axis,
the gas strut comprises a first end that pivotally attaches to the first arm at a point that is above the first line, and
the gas strut comprises a second end that pivotally attaches to the second arm at a point that is below the second line.

12. The adjustable tire carrier of claim 1, wherein the first pivot axis and the third pivot axis are positioned such that, when the first member is attached to a rear portion of the vehicle and the vehicle is positioned on horizontal surface, the first pivot axis is positioned above the third pivot axis, and the third pivot axis is positioned rearward of the first pivot axis.

13. An adjustable tire carrier, comprising:
a first member configured to be attached to a vehicle;
a second member configured to have a spare tire attached thereto;
a first linkage and a second linkage, each of the first and second linkages having a first end pivotally coupled to the first member, and a second end pivotally coupled to the second member,
wherein the first and second linkages are configured to enable the second member to move with respect to the first member between a raised position and a lowered position;
a biasing member configured to bias the second member toward the raised position; and
a locking system configured to selectively prevent the second member from moving with respect to the first member.

14. The adjustable tire carrier of claim 13, wherein the first linkage is parallel to the second linkage.

15. The adjustable tire carrier of claim 13, wherein the first linkage is non-parallel to the second linkage in at least the raised position or the lowered position.

16. The adjustable tire carrier of claim 13, wherein the biasing member comprises a gas strut.

17. The adjustable tire carrier of claim 13, wherein:
the first member comprises two side walls connected to a back wall to form a first cavity between the two side walls,
the second member comprises two side walls connected to a front wall to form a second cavity between the two side walls of the second member,
the first ends of the first and second linkages are positioned within the first cavity, and
the second ends of the first and second linkages are positioned within the second cavity.

18. The adjustable tire carrier of claim 13, wherein the locking system comprises a pin coupled to one of the first member or the second member, the pin positioned to selectively engage one or more holes in a part connected to or formed as part of the first linkage, the second linkage, or the other of the first member or the second member.

19. The adjustable tire carrier of claim 13, wherein the locking system comprises a plurality of clutch plates configured to resist rotational motion when a longitudinal clamping force is applied to the plurality of clutch plates.

20. An adjustable tire carrier, comprising:
a first member configured to be attached to a vehicle;
a second member configured to have a spare tire attached thereto;
an adjustment mechanism configured to selectively move the second member with respect to the first member between a raised position and a lowered position; and
a locking member configured to selectively retain the second member in at least one of the raised position or the lowered position.
